(19) United States
(12) Patent Application Publication
(10) Pub. No.: US 2024/0054240 A1
(43) Pub. Date: Feb. 15, 2024

(54) Machine-Learning Augmented Access Management System

(71) Applicant: SAP SE, Waldorf (DE)

(72) Inventors: Steve Amihai Ben Ezra, Berlin (DE); Rami Al Rihawi, Berlin (DE); Yating Li, Berlin (DE); Kanchana Rao, Bangalore (IN); Lucas Ferraz Pessoa, Berlin (DE); Poonyachote Methaphon, Bangkok (TH); Dominick Joseph Ferro, San Diego, CA (US)

(21) Appl. No.: 17/888,328

(22) Filed: Aug. 15, 2022

(51) Int. Cl. G06F 21/60; G06F 21/62

(52) U.S. Cl. CPC G06F 21/604; G06F 21/6218; G06F 2221/2141

(57) ABSTRACT

Computer-readable media, methods, and systems are disclosed for assisting users in gaining and granting authorization roles by automating some or all of the processes. A method can include creating an authorization request for a first user, retrieving contextual information from a repository, generating suggested authorization roles for the first user based on the contextual information using a peer-based machine learning recommendation system, presenting the suggested authorization roles to the first user in a user interface, selecting at least one authorization role, and submitting the authorization request to an access management system to provide the first user with targeted access to at least one requested system.

### BACKGROUND

Many access control solutions struggle to support an increasingly complex system and process environment due to accelerated digitalization, hybrid on-premise and cloud landscapes, growing amounts of data and access points due in part to remote/mobile work, and increased cybersecurity concerns. A significant majority of data breaches can be directly attributed to misuse of privileged user access, with an average cost of millions of dollars for each data breach. At the same time, current access control systems have very little true understanding of individual users and their needs, which means the system cannot truly help users to painlessly and compliantly gain and manage access to the technical resources needed to get their work done. The current processes around gaining and granting authorization roles can be lengthy, time consuming, confusing, manual, and inefficient.

### SUMMARY

Disclosed embodiments address the above-mentioned problems by providing one or more non-transitory computer-readable media storing computer-executable instructions that, when executed by a processor, perform a method for creating an assisted authorization request including recommendations based on machine learning.

In some aspects, the techniques described herein relate to one or more non-transitory computer-readable media storing computer-executable instructions that, when executed by at least one processor, perform a method for augmented access control. The method includes creating an authorization request for a first user, retrieving contextual information from a repository, wherein said contextual information is associated with information about an identity of the first user and the authorization request, generating a plurality of suggested authorization roles for the first user based on the contextual information using a peer-based machine learning recommendation system, presenting the plurality of suggested authorization roles to the first user in a user interface, selecting at least one authorization role from the plurality of suggested authorization roles, and submitting the authorization request including the selected at least one authorization role to an access management system to provide the first user with targeted access to at least one requested system.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present teachings will be apparent from the following detailed description of the embodiments and the accompanying drawing figures.

### BRIEF DESCRIPTION OF THE DRAWING FIGURES

Embodiments are described in detail below with reference to the attached drawing figures, wherein:

FIG. 1 is a system diagram illustrating an architecture to support the method described herein;

FIG. 2 illustrates a flow diagram of an exemplary process for providing augmented access control;

FIG. 3A shows an embodiment of a process for a user creating an authorization request;

FIG. 3B shows an embodiment of a process for an approver receiving authorization requests;

FIG. 3C shows an exemplary user interface (UI) for a requester creating a request;

FIG. 4 shows a flow process for an approver reviewing authorization requests;

FIG. 5 shows a sample user interface (UI) for an approver reviewing authorization requests;

FIG. 6 shows a process for a system compliance audit; and

FIG. 7 is a diagram illustrating a sample computing device architecture for implementing various aspects described herein.

The drawing figures do not limit the present teachings to the specific embodiments disclosed and described herein. The drawings are not necessarily to scale, emphasis instead being placed upon clearly illustrating the principles of the disclosure.

### DETAILED DESCRIPTION

Disclosed herein are systems and methods to assist users in gaining and/or granting authorization roles by automating some or all of the processes.

Access control solutions govern access authorizations across an organization to ease access and minimize mistakes, misuse and financial loss. A user who is a requester or approval seeker is a user who is requesting access to particular systems and/or resources. A user who is an approver is a user who has the ability to review the authorization request from the requester and either grant or deny the request and associated access.

Users who are seeking approval may not know which authorization role to request as there may be thousands of unique roles, each which provide different levels of access to different data. Augmented access control provides context awareness to the access control solutions via contextual recommendations, assistive decision making and autonomous/proactive processes.

In an embodiment, the system automatically detects relevant authorization roles that the user might require in order for them to achieve a particular task or project. This automatic detection may be based on the user's organizational, task, and peers' authorization profiles context.

In an embodiment, the system provides targeted information together with a confidence score to an approver. This information can assist the approver in deciding whether or not to grant the requester the requested authorization role(s).

In an embodiment, the system automatically routes authorization requests. This routing may be based on context awareness of approvers and their delegates with respect to availability, workload, and expertise.

In an embodiment, a combination of prior embodiments may be used to automate and simplify periodic compliance specific authorization roles management. The system automatically triggers a compliance audit by a mass review of authorization roles based on usage context and automatically assigns the relevant available approver.

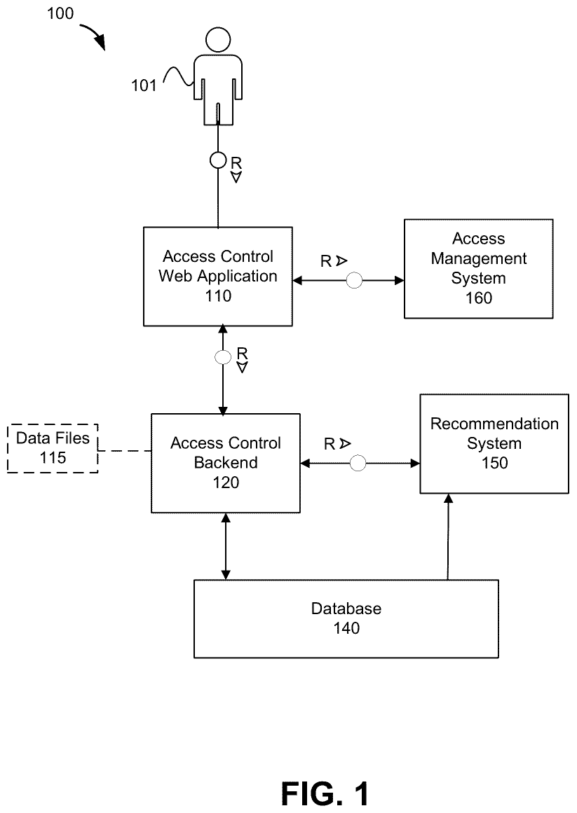

FIG. 1 is a block diagram of computing environment 100 for an embodiment. User 101 provides contextual information to receive an authorization role recommendation and sends a request to the access control web application 110. In turn, access control web application 110 sends a request to access control back end 120. Access control backend 120 is connected to database 140, which contains user information and access information. For example, in some embodiments, database 140 may contain user information gathered from human resource data. In some embodiments, database 140 may contain access information in the form of a knowledge graph. In some embodiments, exemplary data may include access request history, user system access logs, authorization role data, organizational information, personalized information, and user activities. In some embodiments, database may be integrated to gather information from other systems, such as email applications, calendar applications, and messaging applications. Access control backend 120 is also connected to data files 115, which may be CSV files or database dumps, for example. Access control backend 120 may load data such as, human resource data, access data, and access history data, from the data files 115. Access control back end 120 is also connected to recommendation system 150. Access control back end 120 may send a request to recommendation system 150 to retrieve a list of recommended authorization roles. In some embodiments, the response may include a confidence score and/or an explanation for each recommended authorization role. In some embodiments, the explanation may be generated by machine learning based on peer-based and/or explainable AI technology techniques. Access control web application 110 sends an authorization request to access management system 160 after receiving a response from the access control back end 120.

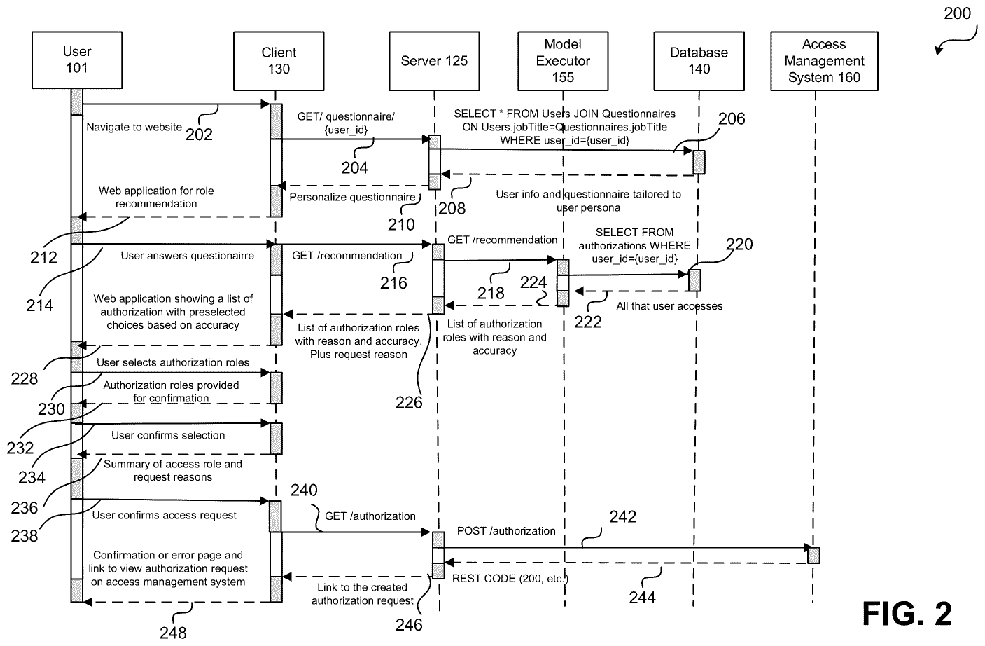

FIG. 2 illustrates a flow diagram of the process 200. At step 202, user 101 navigates to a website on client 130, which may be a browser accessing the web application from a web server. The website may host access control web application 110 (shown in FIG. 1). At step 204, client 130 sends a request to access control backend 120 on server 125 to get a questionnaire. An exemplary request may be in the form of: GET/questionnaire/{user_id}. At step 206, server 125 sends a request to database 140 so that the questionnaire can be customized to the particular user. In some embodiments, the questionnaire may be one or more questions presented to the user on a user interface. In some embodiments, the questions are presented with a plurality of answer choices. In some embodiments, the user can enter natural language text as an answer. An exemplary request may be in the form of: SELECT * FROM Users JOIN Questionnaires ON Users.jobTitle=Questionnaires.jobTitle WHERE user_id={user_id}. For example, in some embodiments, the questionnaires may be categorized by a particular job title, a particular user group or work group, or a job description. In some embodiments, each questionnaire may be tied to a user persona or a particular job description or task description. At step 208, the database 140 returns user information and a specific questionnaire tailored to a first user persona to server 125. At step 210, server 125 sends the personalized questionnaire to client 130. At step 212, client 130 presents the personalized questionnaire to user 101 via a user interface in access control web application 110.

At step 214, user 101 answers the questionnaire and the information is received by client 130. At step 216, client 130 sends a request to server 125 to receive a recommendation. An exemplary request may be in the form of: GET/recommendation. At step 218, server 125 sends a request to model executor 155, which may be part of recommendation system 150 (shown in FIG. 1), to get a recommendation. An exemplary request may be in the form of: GET/recommendation. At step 220, model executor 155 sends a request to database 140 to receive authorization roles allowed based on the answers in the questionnaire. An exemplary request may be in the form of: SELECT FROM authorizations WHERE user_id={user_id}. At step 222, database 140 sends information on all the systems that the user accesses to model executor 155. At step 224, model executor 155 sends a list of suggested authorization roles, along with a reason for suggesting and the accuracy/confidence level of the suggestion. At step 226, server 125 sends the list of authorization roles, the request reason, and the accuracy. Additionally, a request reason is added to the information that is sent to client 130. At step 228, the web application 110 presents a list of authorization roles with preselected choices based on accuracy in a user interface, such as user interface 360, such as in table 370. At step 230, user 101 selects one or more authorizations roles to be submitted for the approval request. At step 232, the authorization roles are provided to user 101 for confirmation and user 101 confirms selection at step 234. At step 236, client 130 provides a summary of the authorization roles and request reasons in a user interface, such as user interface 360. At step 238, user 101 confirms the access request, such as by clicking request button 392. At step 240, client 130 sends a request for authorization to server 125. An exemplary request may be in the form of: GET/authorization. At step 242, server 125 sends an authorization request to access management system 160. An exemplary request may be in the form of: POST/authorization. At step 244, access management system 160 returns information to server 125. The return information may be in the form of: REST CODE (200, etc.). At step 246, server 125 sends a link to the created authorization request to client 130. At step 248, client 130 presents a confirmation page or an error page to user 101. In some embodiments, confirmation page will include a link to view the authorization request on the access management system 160.

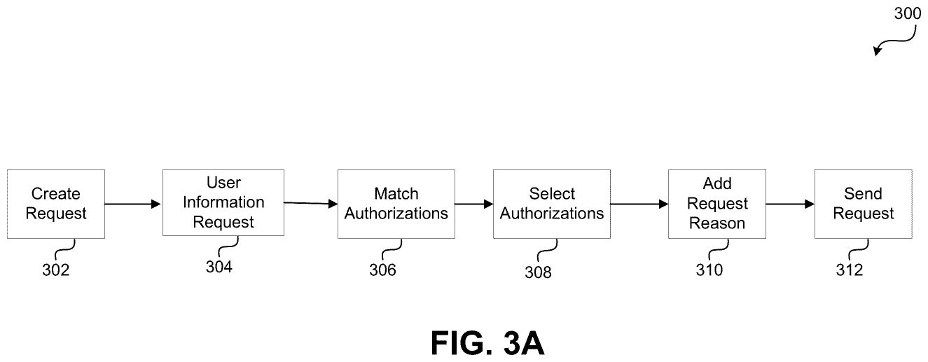

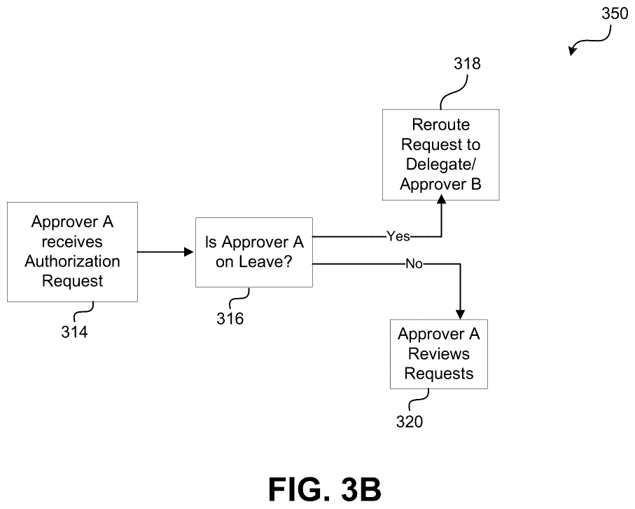

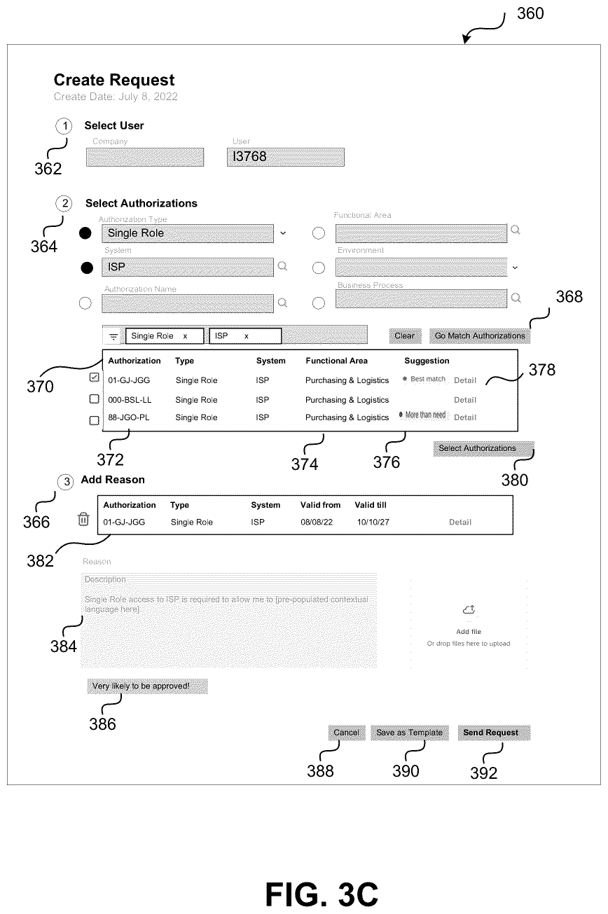

FIG. 3A shows an embodiment of a process flow 300. At step 302, a request is created. In some embodiments, this may be a manual request created by user 101. In some embodiments, this may be an autonomous request created by the system. An autonomous request may be triggered by using insight discovery into other applications utilized by the user. For example, a trigger may be an email message asking the user to perform a particular task, for which the user may need additional authorization to access the necessary information. Another example of a trigger may be usage of an application that is currently used with an additional tool to which the user does not currently have authorization. Another exemplary trigger may be a system event that a user is attending and for which they will need access to a particular application. In some embodiments, the system may conduct a periodic check to determine if a particular access is needed. In some embodiments, automatic triggering may be a result of monitoring user activity. For example, when a user tries to access a certain system and/or data and is denied access and/or receive a permissions error, this may be a trigger. In another example, a user may try to access a particular system and/or data or a combination of systems/data that suggests a certain intent and triggers the system to suggest additional access to fulfill the intent.

Other triggers may be determined by the recommendation system 150 based on other user's requests (profiles of peers) or based on the user's activity in multiple systems. In some embodiments, the request may be created and sent by the system without any user input. In some embodiments, the request may be created by the recommendation system 150 but the user can have input at one or more steps in the process, such as selecting the authorization role, editing the reason for request, and/or confirming the authorization role before submitting the request.

In one embodiment, a user may receive an email from a supervisor asking him to prepare a report for Project P on a budget for Region A on Product X within a month. The recommendation system 150 may automatically create a request for read-only access to System ABC, which includes monetary information on Product X, and for read-only access to System XYZ, which includes geographical information on Region A, with an expiration date of two months. The recommendation system 150 may present the suggested authorization roles to the user in a user interface, along with the pre-populated reason of “Create report for Project P on a budget for Region A on Product X within a month.” The user can simply confirm the request and send it to the access management system 160 with limited time and effort. This automated request eliminates wasted time and expedites the approval process to improve productivity.

At step 304, a user information request is presented to the user so that the system can understand the particular access needs of the user at that time. The information request may be in the form of a user questionnaire, which may be open-ended or may include selectable choices. In some embodiments, the questionnaire may be presented to a user in a number of successive windows, or in one screen. In some embodiments, the questions may be customized to the user based on the user persona. In some embodiments, such as where the request is created autonomously during step 302, step 304 may be skipped entirely. Alternatively, step 304 may be shortened or altered to ask more directed questions based on prior autonomously gathered data. At step 306, match authorization roles are provided to user 101 by the system. The suggested match authorization roles are recommendations based on which authorization roles may be needed to complete a task based on the answers of the questionnaire and other collected data. Thus, rather than a user having to guess regarding which authorization role is to be chosen, the system will automatically suggest roles, using recommendation system 150, based on the context of the requester's position and what tasks the requester is required to perform. In some embodiments, the system scores the most likely accesses the user should have and lists them from the most likely to the least likely in the user interface display.

Rather than a user being given unrestricted access to an application or system, a user can select a particular authorization role as well as the particular system to which they want to gain access. Thus, for example, depending on the chosen authorization role the user may be given the ability to only perform read functions, only perform write functions, or perform both read and write functions. Additionally, if the user has an authorization role such as an administrator, they may be given greater access to modify other user's authorizations. It is important that the correct authorization role be chosen so that the user does not have too much access and does not have too little access. Too little access can prevent the user from being able to access the appropriate amount of information to perform their job. Too much access may open the network up to unnecessary security risks. For instance, if this user has their credentials hacked, the intruder may gain access to all of the systems that the user has access to, which may be many systems and/or applications.

At step 308, a user may manually select an authorization role for which he wants to submit a request. In order to assist the approver in determining if the request is appropriate, the user must provide a justification for the user's request. At step 310, the user can enter a request reason. Step 310 can be entirely manual or can be partially automated in that a suggested reason may be provided by recommendation system 150, which the user 101 can alter before submitted. At step 312, user 101 sends the authorization request to access management system 160. In some embodiments, step 312 may be entirely manual. In some embodiments, step 312 may be partially or wholly automated such that the system may auto-create and submit a request upon a user's approval.

FIG. 3B shows a flow process 350 for submitted access requests. At step 314, a first approver (Approver A) receives the request from step 312. At step 316, the system determines if Approver A is on leave. Approver A may enter their leave, such as an expected or unexpected out of office (OOO), into the system and/or into another application such as a calendar. The system may automatically detect the leave of the Approver A, such as by reviewing the approver's calendar. In some embodiments, there may be a threshold for determining if the quantity of leave qualifies as necessary for re-routing, or if the leave is short (such as 1 day), then the system may still proceed to step 320. If it is determined that Approver A is on leave and therefore unavailable for a specific period of time, at step 318, the system re-routes any pending requests to another available qualified approver, such as a delegate or Approver B. In some embodiments, Approver A may proactively select one or more delegates in the system settings or preferences at a time before they are unavailable. In some embodiments, Approver A may select different delegates for different types of requests or for different time periods. The requests are then reviewed by the delegate or Approver B according to process 400, as described below. If it is determined that Approver A is not on leave and therefore available, at step 320, authorization requests are reviewed by Approver A according to process 400, as described below. In some embodiments, Approver A may also choose to route one or more requests to a delegate or another approver even if they are available.

FIG. 3C shows an exemplary user interface (UI) 360 for a requester who is creating a request, such as at step 302. In some embodiments, user interface 360 may include three sections: select user section 362, select authorization section 364, and add reason section 366. In select user section 362, a user enters personal information, such as company information and user identification information. In some embodiments, this information may be pre-populated by the system. In select authorization section 364, a user can select the appropriate authorization roles desired. In some embodiments, fields may include: authorization type, system, authorization name, functional area, environment, and/or technical or business process. For each field, a drop-down list and/or a search function may be provided for a user to select from. Once a user has entered information in at least one of the fields, the user can click on a search button 368, such as “go match authorizations.” Upon clicking this search button 368, the system will retrieve data using recommendation system 150 for presenting choices to the user 101 in user interface 360. A number of suggested authorization roles 372 with the user's specified requirements can be rendered in table 370 such that the user can select the desired authorization role(s). In some embodiments, the suggestions are provided together with additional information, such as a functional area 374 and a suggestion 376 of whether or not the user should select this choice, such as the accuracy of the selection. In some embodiments, there is also a clickable “details” button 378 to allow the user to view more information about each choice. For example, when a user clicks on the details button 378, a pop-up window may appear including additional information, such as what this authorization role will provide access to, and which users or workgroups have access to this authorization role. A user can then select the authorization roles that they wish to request access to by clicking on button 380, such as “select authorizations”.

At reason section 366, a table 382 showing the authorization roles selected above at 380 will be displayed, along with an automatically filled expiration date field. In some embodiments, the user can enter a reason for why they are requesting access to this authorization role. In some embodiments, the reason field 384 will automatically be at least partially populated by the system. In some embodiments, a user can modify the information in the reason field 384 and can also optionally add files. Based on the information entered, the recommendation system 150 may also generate a predicted response 386, such as “very likely to be approved.” The predicted response may be generated by a machine learning model trained on previous requests being rejected or approved and the associated user information. The user interface 360 may also include buttons for cancelling the request 388, saving the request as a template 390, or submitting the request 392 (such as at step 312).

The recommendation system 150 may use machine learning techniques to determine the proper authorization roles and suggested reasons for requesting. In some embodiments, the suggested reasons may be based on natural language processing. Based on information received from the current user responses, information received from prior responses by the same user, and information received from prior responses by different users, the recommendation system 150 can match the current user to a particular persona. The recommendation system 150 can determine based on other users, such as a peer user in a similar job position who needs to perform a similar task, what authorization roles the current user may need to perform the current task.

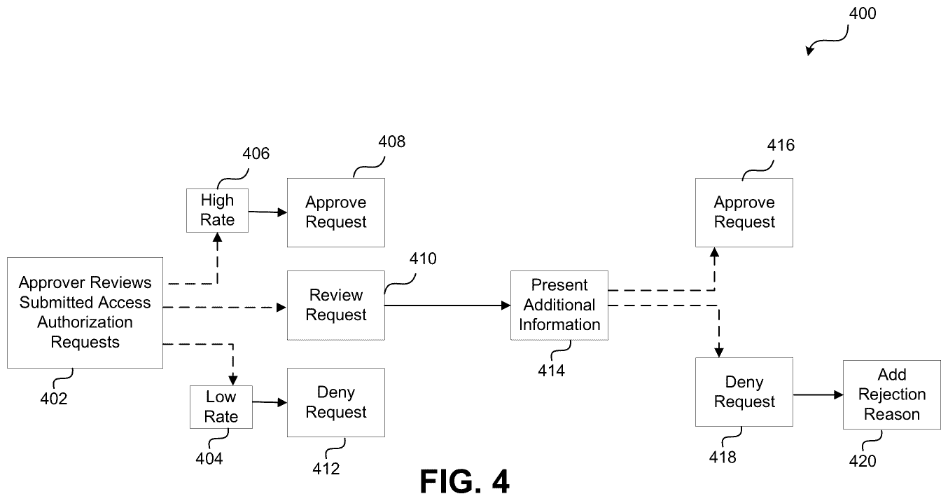

FIG. 4 shows a flow process 400 for reviewing submitted access authorization requests. At step 402, an approver reviews a list of submitted access authorization requests. At step 404, the system determines that there is a low confidence rating that the requester should have the request approved. The process 400 proceeds from step 404 to step 412 to deny the request when the confidence level is below a threshold. Conversely, at step 406, the system determines that there is a high confidence rating that the requester should have the request approved. The process 400 proceeds from step 406 to step 408 to approve the request when the confidence level is above a threshold without further review. In some embodiments, the threshold can be automatically determined or manually set for each particular user. The system can review prior decisions of a particular user and create a personalized ruleset. Additionally, or alternatively, the system can set a default threshold. For example, if it is highly likely (such as greater than 80%) that the requester needs the authorization for their job responsibility (based on the requester's user profile and other user information), then the confidence rating will be high. As another example, if is it very unlikely (such as less than 20%) that the requester needs the authorization for their job responsibility, then the confidence rating will be low. In some embodiments, the high level of the threshold may be set as above 70%, above 80%, or above 90% and the low level of the threshold may be set as below 30%, below 20%, or below 10%. In some embodiments, the rejection may include a machine-generated reasoning. In some embodiments, if rejected, the requester can either edit the generated request or create new request, or request manual approval.

If the confidence level is in a middle range, the process proceeds to step 410 to further review the request. In some embodiments, if the confidence rating is between 30-70%, the approver needs to provide manual input. In some embodiments, if the confidence rating is between 40-60%, the approver needs to provide manual input. At step 414, the system presents further information to the approver in a user interface so the approver can review. Additional information may provide specific information about the requester and the requester's context. Based on this additional information, the approver then approves the request at step 416 or denies the request at step 418. In some embodiments, following step 416 or 418, the requester is notified of the approval or denial, such as by a message on the UI. At step 420, the system may optionally provide an automated template for a rejection reason before sending the denial to the requester. In some embodiments, the approver may edit the rejection reason.

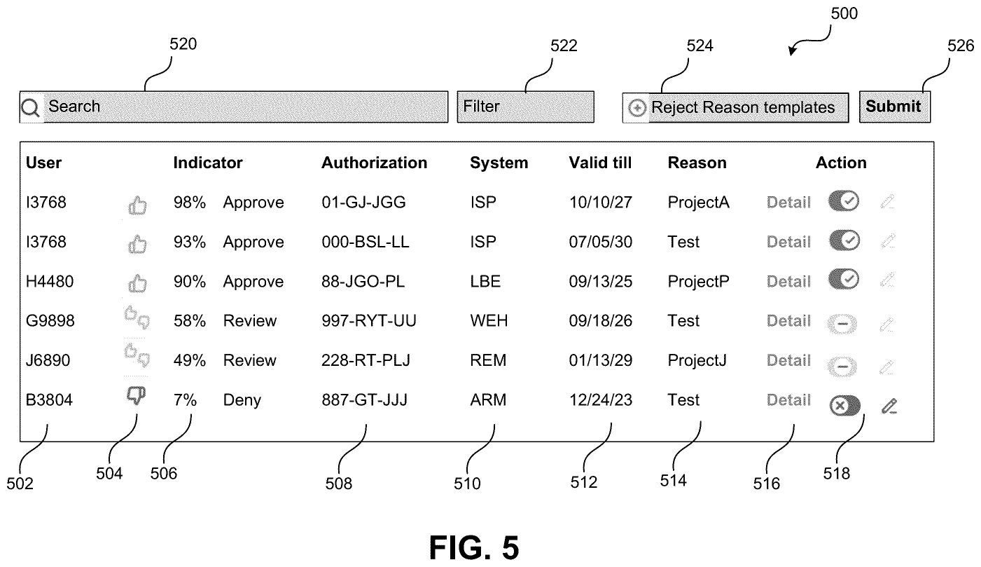

FIG. 5 shows a sample user interface (UI) for an approver. In some embodiments, the UI may include the following fields: user column 502, confidence indicator column (including an icon 504 indicating the suggested action to take and the percentage confidence level 506 for the particular request), authorization column 508, system column 510, date column 512, reason column 514, detail column 516, and action column 518. Date column 512 may indicate a date when the authorization will expire, as this may be useful in determining if the authorization should be granted. For example, if the expiration is very soon, it may be more likely that the authorization should be granted as this presents a lower security risk. Detail column 516 may include clickable links to open up an additional window that will display further details of the reason the requester has entered. Detail clickable link may also provide further user details to assist in the determination of approval, such as for the medium confidence requests. A button in action column 518 may allow the user to choose to approve or deny the request. In some embodiments, the UI may also include a search box 520, a filter button 522, a button 524 to access the reject reason templates, and a submit button 526. When the approver clicks on submit button 526, the actions in column 518 will be entered into the system, and the requester will be sent a notification and thereafter allowed or denied access to the requested systems, such as at step 416 or step 418 and step 420.

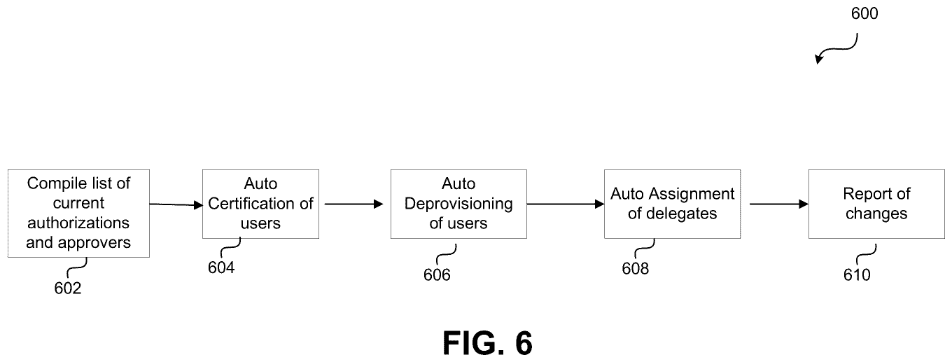

FIG. 6 shows a process 600 for a compliance audit. The recommendation system 150 will periodically perform a mass review all authorizations to determine if they are still appropriate. At step 602, the recommendation system 150 will compile a list of all current authorization roles. At step 604, the recommendation system 150 will automatically add certifications to users based on their user profile and comparison to other users with a similar user profile or persona. For example, if User A in workgroup X frequently uses application Y, and User B is a similarly situated person in workgroup X who frequently performs similar tasks, it can be assumed that User B would also need access to application Y. Therefore, the recommendation system 150 may automatically grant certification/authorization to User B for the same application Y without User B needing to submit an authorization request. Thus, recommendation system 150 may preemptively provide User B with the appropriate access before the user even knows that they access is needed. In some embodiments, the recommendation system 150 may provide the recommendation for the authorization role and allow the User B to confirm that they do in fact want access to this authorization role.

At step 606, the system will determine if any users no longer need access to particular applications and will automatically remove their authorizations for these applications. For example, if User A has not utilized the authorization for a particular application for an extended period of time, such as a year, then it may be determined that this authorization is no longer required, and the authorization may be removed. Sometimes a user's job title and/or responsibilities may change, and they may not have removed the authorizations that were previously required but are no longer being used. In some embodiments, the recommendation system 150 will ask the user if he still needs access to this system before removing the user's authorization.

At step 608, the recommendation system 150 will determine which approvers do not have delegates assigned and will automatically assign delegates. In some embodiments, this automated assignment may be based on an organizational hierarchy. If an approver does not have a delegate assigned, this may delay the approval process. At step 610, the system will automatically generate a report of all changes made and automatically send the changes to one or more system owners or administrators.

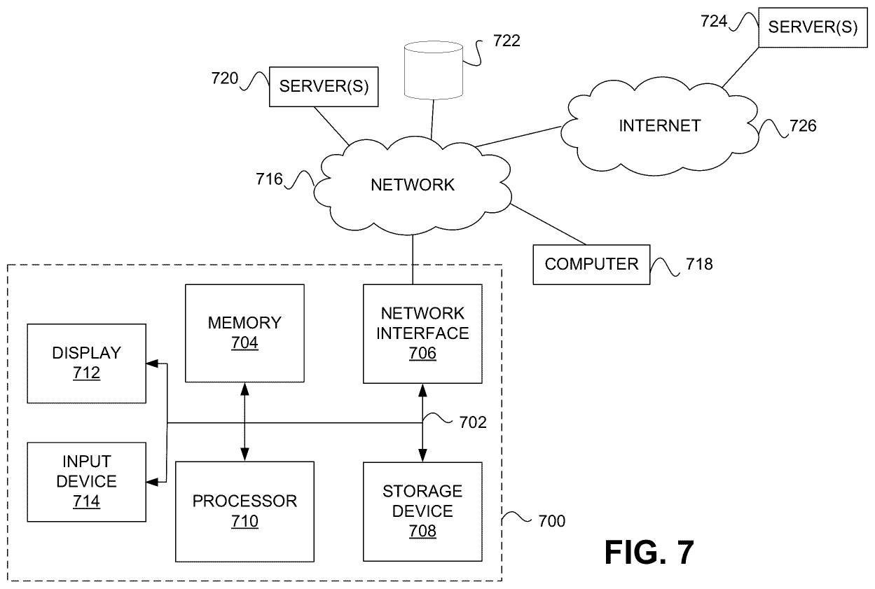

FIG. 7 is a diagram illustrating a sample computing device architecture for implementing various aspects described herein. Computer 700 can be a desktop computer, a laptop computer, a server computer, a mobile device such as a smartphone or tablet, or any other form factor of general- or special-purpose computing device containing at least one processor. Depicted with computer 700 are several components, for illustrative purposes. Certain components may be arranged differently or be absent. Additional components may also be present. Included in computer 700 is system bus 702, via which other components of computer 700 can communicate with each other. In certain embodiments, there may be multiple busses or components may communicate with each other directly. Connected to system bus 702 is at least one processor 710. Also attached to system bus 702 is memory 704. Also attached to system bus 702 is display 712. In some embodiments, a graphics card providing an input to display 712 may not be a physically separate card, but rather may be integrated into a motherboard or processor 710. The graphics card may have a separate graphics-processing unit (GPU), which can be used for graphics processing or for general purpose computing (GPGPU). The graphics card may contain GPU memory. In some embodiments no display is present, while in others it is integrated into computer 700. Similarly, peripherals such as input device 714 is connected to system bus 702. Like display 712, these peripherals may be integrated into computer 700 or absent. Also connected to system bus 702 is storage device 708, which may be any form of computer-readable media, such as non-transitory computer readable media, and may be internally installed in computer 700 or externally and removably attached.

Computer-readable media include both volatile and nonvolatile media, removable and nonremovable media, and contemplate media readable by a database. For example, computer-readable media include (but are not limited to) RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data temporarily or permanently. However, unless explicitly specified otherwise, the term “computer-readable media” should not be construed to include physical, but transitory, forms of signal transmission such as radio broadcasts, electrical signals through a wire, or light pulses through a fiber-optic cable. Examples of stored information include computer-useable instructions, data structures, program modules, and other data representations.

Finally, network interface 706 is also attached to system bus 702 and allows computer 700 to communicate over a network such as network 716. Network interface 706 can be any form of network interface known in the art, such as Ethernet, ATM, fiber, Bluetooth, or Wi-Fi (i.e., the Institute of Electrical and Electronics Engineers (IEEE) 802.11 family of standards). Network interface 706 connects computer 700 to network 716, which may also include one or more other computers, such as computer 718, and network storage, such as cloud network storage. Network 716 is in turn connected to public Internet 726, which connects many networks globally. In some embodiments, computer 700 can itself be directly connected to public Internet 726. Network 716 may be connected to one or more servers 720, 724, either directly or via Internet 726. Network 716 may also be connected to a cloud storage device 722, such as a database, like database 140.

In some embodiments, database 140 may contain user information from multiple sources. User information may include data about the user such as identity (passwords, fingerprints, face signature, other identity-based biometrics), name, address, number of years employed, job title, workgroup, organizational unit, organizational role, organizational responsibilities/tasks, cost center, access permissions, past and present projects, development goals, personality profile, emotional profile, credentials (work history, academics, professional certifications), availability profile (planned leave), etc.

Additional information may include data about a user's activities and interactions with the environment. For example, data may include tool preferences (for messaging, conferencing, document management), calendar schedule/meetings, emails, chats, videos, document interactions, business travel, web browsing and search history, location, etc.

Additional data may include data about a user's interactions with business objects, such as particular tasks that the user performs frequently or infrequently, user activities, interactions with other users, applications frequently or infrequently used, business process workflow, business object metrics, etc. Information may be compiled, for example, from a user's e-mail, calendar, documents, or user logs. Data can be collected with or without the user's input.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system can include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “computer-readable medium” refers to any computer program product, apparatus and/or device, such as for example magnetic discs, optical disks, memory, and Programmable Logic Devices (PLDs), used to provide machine instructions and/or data to a programmable processor, including a computer-readable medium that receives machine instructions as a computer-readable signal. The term “computer-readable signal” refers to any signal used to provide machine instructions and/or data to a programmable processor. The computer-readable medium can store such machine instructions non-transitorily, such as for example as would a non-transient solid-state memory or a magnetic hard drive or any equivalent storage medium. The computer-readable medium can alternatively or additionally store such machine instructions in a transient manner, for example as would a processor cache or other random-access memory associated with one or more physical processor cores.

Many different arrangements of the various components depicted, as well as components not shown, are possible without departing from the scope of the claims below. Embodiments have been described with the intent to be illustrative rather than restrictive. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims. Although described with reference to the embodiments illustrated in the attached drawing figures, it is noted that equivalents may be employed, and substitutions made herein without departing from the scope of the disclosure as recited in the claims. The subject matter of the present disclosure is described in detail below to meet statutory requirements; however, the description itself is not intended to limit the scope of claims. Rather, the claimed subject matter might be embodied in other ways to include different steps or combinations of steps similar to the ones described in this document, in conjunction with other present or future technologies. Minor variations from the description below will be understood by one skilled in the art and are intended to be captured within the scope of the present claims. Terms should not be interpreted as implying any particular ordering of various steps described unless the order of individual steps is explicitly described.

The following detailed description of embodiments references the accompanying drawings that illustrate specific embodiments in which the present teachings can be practiced. The described embodiments are intended to illustrate aspects of the disclosure in sufficient detail to enable those skilled in the art to practice the present teachings. Other embodiments can be utilized, and changes can be made without departing from the claimed scope of the present teachings. The following detailed description is, therefore, not to be taken in a limiting sense. The scope of embodiments is defined only by the appended claims, along with the full scope of equivalents to which such claims are entitled.

Having thus described various embodiments, what is claimed as new and desired to be protected by Letters Patent includes the following:

1. One or more non-transitory computer-readable media storing computer-executable instructions that, when executed by at least one processor, perform a method for augmented access control comprising:
creating an authorization request for a first user;
retrieving contextual information from a repository, wherein said contextual information is associated with information about an identity of the first user and the authorization request;
generating a plurality of suggested authorization roles for the first user based on the contextual information using a peer-based machine learning recommendation system;
presenting the plurality of suggested authorization roles to the first user in a user interface;
selecting at least one authorization role from the plurality of suggested authorization roles; and
submitting the authorization request including the selected at least one authorization role to an access management system to provide the first user with targeted access to at least one requested system.

2. The non-transitory computer-readable media of claim 1, wherein the authorization request includes an associated reason for the authorization request,
wherein the associated reason is generated by the peer-based machine learning recommendation system.

3. The non-transitory computer-readable media of claim 1, wherein the method further comprises:
generating a suggested reason for the authorization request based on the contextual information using the peer-based machine learning recommendation system;
presenting the suggested reason to the first user in the user interface; and
allowing the first user to edit the suggested reason.

4. The non-transitory computer-readable media of claim 1, wherein the method further comprises:
before generating the plurality of suggested authorization roles, requesting additional information directly from the first user via the user interface by presenting a plurality of questions.

5. The non-transitory computer-readable media of claim 4, further comprising:
receiving at least one response to the plurality of questions from the first user, wherein said at least one response is selected from a plurality of provided choices or is a natural language response.

6. The non-transitory computer-readable media of claim 1, further comprising:
presenting an explanation of why each of the plurality of suggested authorization roles is suggested for the first user, wherein the explanation is generated using the peer-based machine learning recommendation system.

7. The non-transitory computer-readable media of claim 1, wherein creating the authorization request is automatically triggered by information extracted from email messages, instant messages, calendar entries, or documents associated with the first user.

8. The non-transitory computer-readable media of claim 1, wherein the method further comprises:
automatically approving or denying the authorization request based on a predicted confidence level generated by the peer-based machine learning recommendation system.

9. A computing system to provide augmented access control, comprising:
at least one processor; and
at least one non-transitory machine-readable medium storing computer executable instructions that when executed by the at least one processor cause the system to:
automatically create an authorization request for a first user based on a first trigger using a peer-based machine learning recommendation system;
retrieve contextual information from a repository, wherein said contextual information is associated with information about an identity of the first user and the authorization request;
generate a plurality of suggested authorization roles for the first user based on the contextual information using the peer-based machine learning recommendation system;
present the plurality of suggested authorization roles to the first user in a user interface;
select at least one authorization role from the plurality of suggested authorization roles; and
submit the authorization request including the selected at least one authorization role to an access management system to provide the first user with targeted access to at least one requested system.

10. The system of claim 9, wherein the authorization request includes an associated reason for the authorization request, said associated reason generated by the peer-based machine learning recommendation system.

11. The system of claim 9, wherein the first trigger is information extracted from email messages, instant messages, calendar entries, or documents associated with the first user.

12. The system of claim 9, further causing the system to:
generate a suggested reason for the authorization request based on the contextual information using the peer-based machine learning recommendation system; and
present the suggested reason to the first user in the user interface; and
allow the first user to edit the suggested reason.

13. The system of claim 9, further causing the system to:
before generating the plurality of suggested authorization roles, receive at least one response to a plurality of questions from the first user, wherein said at least one response is selected from a plurality of provided choices or is a natural language response.

14. The system of claim 9, further causing the system to:
present an explanation of why each of the plurality of authorization roles is suggested for the first user, said explanation generated using the peer-based machine learning recommendation system.

15. A method for augmented access control using machine-based learning comprising:
creating an authorization request for a first user;
retrieving contextual information from a repository, wherein said contextual information is associated with information about an identity of the first user and the authorization request;
generating a plurality of suggested authorization roles for the first user based on the contextual information using a peer-based machine learning recommendation system;
presenting the plurality of suggested authorization roles to the first user in a user interface;
selecting at least one authorization role from the plurality of suggested authorization roles; and
submitting the authorization request including the selected at least one authorization role to an access management system to provide the first user with targeted access to at least one requested system.

16. The method of claim 15, wherein creating the authorization request is automatically triggered by information extracted from email messages, instant messages, calendar entries, or documents associated with the first user.

17. The method of claim 15, further comprising:
generating a suggested reason for the authorization request based on the contextual information using the peer-based machine learning recommendation system; and
presenting the suggested reason to the first user in the user interface.

18. The method of claim 15, further comprising:
generating an explanation of why each of the plurality of authorization roles is suggested for the first user using the peer-based machine learning recommendation system; and
presenting the explanation to the first user in the user interface.

19. The method of claim 15, further comprising:
automatically approving or denying the authorization request based on a predicted confidence level generated by the peer-based machine learning recommendation system.

20. The method of claim 15, further comprising:
before generating the plurality of suggested authorization roles, requesting additional information from the first user via the user interface.
